(19) United States
(12) Patent Application Publication
(10) Pub. No.: US 2010/0017856 A1
(43) Pub. Date: Jan. 21, 2010

(54) BIOMETRIC RECORD CACHING

(76) Inventors: Dwayne Mercredi, Alberta (CA); Rod Frey, Alberta (CA); Gregory C. Jensen, Redmond, WA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/493,938

(22) Filed: Jun. 29, 2009

Related U.S. Application Data
(63) Continuation of application No. 10/398,360, filed on Apr. 4, 2003.

(51) Int. Cl. H04L 9/32; G06F 15/16; G06F 21/00

(52) U.S. Cl. 726/4; 713/186

(57) ABSTRACT

An apparatus, method and program product locally stores biometric data in response to a user accessing a network (38). Local storage of the biometric data allows the user to biometrically access a local computer (20) in the absence of a network connection (18)and/or submitted ID.

### FIELD OF THE INVENTION

The present invention relates generally to biometric technologies, and more particularly, to biometrically-controlled access of computer resources.

### BACKGROUND OF THE INVENTION

Considerations regarding the safeguarding of computer resources have become ubiquitous throughout industry, government and private channels. Security concerns are exacerbated in networked environments, where the desire to exchange data is often at odds with attempts to ensure system integrity. Networks typically include one or more servers and numerous client computer terminals, referred to herein as local computers, communicating over network communication links. The communication links may be comprised of cables, wireless links, optical fibers, and/or other communication media. Similarly, the local computers may be desktop personal computers, laptop computers, PDA's, or other computing devices to which or through which a user desires to obtain access. Secure networks commonly incorporate password software and procedures configured to restrict and control access to the network. However, despite such provision, password-controlled access remains fraught with security concerns, such as ease of duplication. Users may additionally have difficulty remembering passwords.

Consequently, many networks rely on biometric authentication processes to safeguard computer resources. With biometric authentication, a measurable physical characteristic of a potential user is obtained as a signature rather than a password. Such physical characteristics are usually very unique to the user and thus difficult to duplicate, defeat, or forget. Examples include fingerprints, retinal scans and voice signatures. Other examples might include hand, facial and/or cranial measurements and dimensions. For biometric access, a user who desires to access a network must first be enrolled on the network with that person's unique biometric data. That unique biometric data is typically obtained by the user logging in to the network with an administrator who oversees the process, such as at an administrator's or specially designated enrollment computer.

At that designated computer, the user will provide his or her user ID and also provide the requisite biometric data to one or more biometric access devices associated with the computer, such as by placing the appropriate finger in a fingerprint scanner or reader, exposing the eye to a retinal scan, or speaking into a microphone or the like, by way of examples, connected to that designated computer. The administrator typically oversees this process, which results in the generation of a set of data referred to herein as a biometric identification record (“BIR”), or perhaps multiple BIR's depending upon the number and type of biometric access devices to be used. The BIR is then stored on a network server as enrollment BIR data in a file associated with the particularly identified user (“privileged user”), such as by associating the enrollment BIR data with that user's ID.

When a user desires thereafter to access the network through a local computer coupled to the network, the user again provides the ID and the requested biometric information through a biometric access device associated with the local computer. The biometric data captured at the local computer produces a temporary BIR referred to hereinafter as “capture BIR data.” The local computer and the server on the network communicate in an effort to authenticate the capture BIR data with the enrollment BIR data to determine whether the accessing user should be given access as if he or she were the privileged user who had enrolled at the network.

The enrollment BIR data is highly unique, as is the capture BIR data, thus presenting a formidable challenge to falsify, or otherwise defeat for purposes of accessing the network. The same enrollment and capture BIR data techniques can be applied to stand-alone computers as well, provided that the privileged user has gone through the enrollment process at that computer to provide an enrollment BIR thereto. The practical difficulties in having enrollments both at the network and at the local computers become more apparent when the significant time, effort and resources required to provide the enrollment process are understood.

The difficulties become especially compounded in large, enterprises with a great many users and/or local computers. That problem becomes even more exacerbated in enterprises where the various users may move from computer to computer, thus necessitating multiple enrollments. Thus, in a network-based system, users will not typically be enrolled at their local computers. Instead, enrollment will typically be only at the network level, so as to avoid the time and expense of such enrollment procedures for the administrative staff. As a result, then, enrollment is accomplished only once per privileged user at the designated enrollment computer, and the enrollment BIR data held at the network server. That way, the user may seek to login through any local computer on the network using biometric access and the enrollment BIR data is available for the authentication without multiple enrollments.

Limiting enrollment to the network level, however, can present additional drawbacks. For example, there may be times when the user wishes to access the local computer, but the local computer is not able to communicate with the network server. That situation can arise when the network or server is down, or if the local computer is simply disconnected from the network, a not uncommon problem in the case of laptops, PDA's or other mobile computing devices. But, because an enrollment process has not been undertaken with that now-disconnected local computer, the only security available thereon is the traditional and unreliable password method. It would be desirable to still have biometrically controlled access to the local computer, but without requiring that the privileged user have specifically undergone the time consuming enrollment procedure with that particular local computer.

In addition, and as indicated above, the accessing user must provide his or her ID, in addition to the capture BIR data. Where many users enjoy access to the same local computer, the requirement to provide the ID is seen as a practical necessity, but is also the source of frustration and delay. That frustration is particularly evident where the local computer, on an attempted login, brings up the ID of the last user, and the current accessing user does not notice that the ID is for another user. That accessing user will proceed to provide his biometric data, but will not be authenticated because the ID for another user. The result is at least a delay, if not lock-out from the system for that accessing user or perhaps the true privileged user. Such frustrations, among others, may ultimately translate into a reluctance on behalf of users to login with biometric access devices, opting instead for the conventional password approach, with its many security problems.

### SUMMARY OF THE INVENTION

The present invention provides an improved method, apparatus and program product for controlling biometric access to a computer of a user in a manner that addresses above-identified shortcomings of known biometric systems. To this end, and in accordance with the principles of the present invention, after the accessing user seeking access through a local computer is authenticated (i.e., the capture BIR and enrollment BIR data is found to match appropriately), a copy of the enrollment BIR data normally stored on the network server is further stored, or cached, in local computer for later use, such as after the current user has logged out of the network. In that way, the privileged user has automatically become enrolled on the local computer, without going through a formal, additional enrollment process at the local computer.

Instead, the enrollment at the local computer is, essentially, transparent to the user. However, because the copy of the enrollment BIR data, either directly or in encrypted form, is now also available at the local computer, access to the local computer, even when disconnected from the network, can be biometrically controlled without a further enrollment process by the user. The copy store technique may be applied to some or all of the local computers in an enterprise such that the administrative time, and the inconvenience of multiple enrollments that would otherwise militate against using biometrics to control access to the local computers in a stand-alone mode, becomes practical and easily accomplished.

In accordance with a further feature of the present invention, and based on the uniqueness of enrollment BIR data from user to user, it is now possible to also reduce or eliminate the need for user ID's. For example, the local computer may retain the copies of the enrollment BIR data, and associated ID's if necessary, for the last number of authenticated users. Due to the highly correlative nature of BIR data, an accessing user may now be permitted to log in using only capture BIR data, which is then compared against the stored copies of enrollment BIR data for an appropriate match. The absence of the ID is no longer a factor as the enrollment BIR data may be solely relied upon to control access and/or the ID may be retained with the stored copy to provide the same to the network or local computer operating system if otherwise required. In that way, a fast login is accomplished because the delays involved with inputting or correcting the ID are eliminated.

The same fast login technique may be spread up to the network where privileged users, or certain sets of privileged users, may be permitted to login to the network through a local computer without the ID, and based only on a comparison of the capture BIR data and the enrollment BIR data.

By virtue of the foregoing there is thus provided an improved method, apparatus and program product for controlling biometric access to a computer of a user in a manner that addresses above-identified shortcomings of known biometric systems. These and other objects and advantages of the present invention shall be made apparent from the accompanying drawings and the description thereof.

### BRIEF DESCRIPTION OF THE DRAWING

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a block diagram of a networked computer system consistent with the invention;

FIG. 2 is a block diagram of an exemplary hardware and software environment for a computer from the networked computer system of FIG. 1;

FIG. 3 is a flowchart outlining method steps suited for execution within the environments of FIGS. 1 and 2;

FIG. 4 is a flowchart illustrate process steps associated with the BIR caching method of FIG. 3;

FIG. 5 is a dialog box having application within the process steps of FIG. 4;

FIG. 6 is a flowchart illustrating method steps in accordance with the principles of the present invention;

FIG. 7 is a dialog box consistent with the principles of the invention and having particular application within the process steps of FIG. 6.

### DETAILED DESCRIPTION OF DRAWINGS

With reference generally to Drawings, there is shown a system 10 configured to retrieve an enrollment BIR of a privileged user from a server 16 in response to that user gaining access to a network 18. The system 10 locally stores the retrieved BIR data on a computer 20. As such, the enrollment BIR is subsequently available locally for authentication purposes when the computer 20 becomes disconnected from the network IS. Having thus obviated the need to retrieve enrollment data from the network 18, the user is permitted to gain access to the computer 20 irrespective of a network 18 connection.

Further, because the storage of the enrollment BIR data is accomplished locally, BIR data for multiple, prior users may be stored on the local computer 20. This feature allows a user to biometrically access the computer 20 without first providing his or her ID. Namely, a user may solely provide capture BIR data directly to the computer 20, which is evaluated against the locally stored enrollment BIR data of prior users. The highly correlative nature of the BIR's facilitate matching of the capture and enrollment data in the absence of a submitted ID. A subsequent correlation of the capture and enrollment BIR data may verify the status of the accessing user as being privileged as above. These and other exemplary embodiments in accordance with the principles of the present invention are described below in detail.

### Hardware and Software Environment

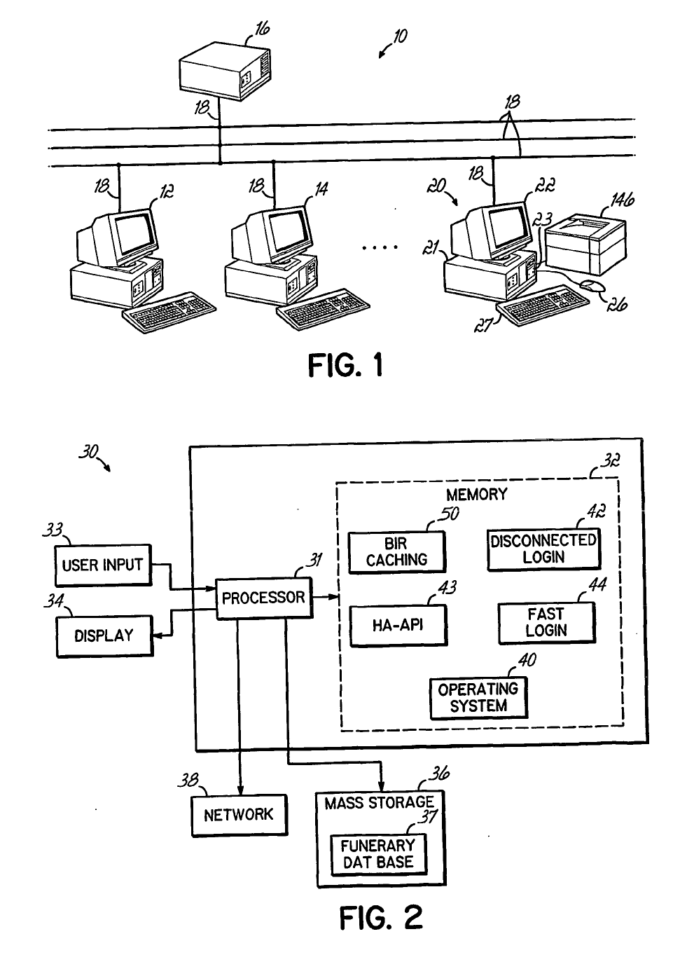

Turning to the Drawings, wherein like numbers denote like parts throughout the several views, FIG. 1 illustrates an exemplary computer system 10 suitable for biometrically controlling access to a user computer 20 adapted to communicate with a network 18. As such, computer system 10 is illustrated as a networked system that includes one or more client computers 12, 14 and 20 (e.g., lap top, desktop or PC-based computers, workstations, etc.) coupled to server 16 (e.g., a PC-based server, a minicomputer, a midrange computer, a mainframe computer, etc.) through a network IS. Network 18 represents a networked interconnection, including, but not limited to local-area, wide-area, wireless, and public networks (e.g., the Internet). Moreover, any number of computers and other devices may be networked through network 18, e.g., multiple servers. Significantly, the present invention may have particular application when a computer 12, 14, 20 becomes disconnected from the network 18.

User computer 20, which may be similar to computers 12, 14, may include: a central processing unit (CPU) 21, a number of peripheral components such as a computer display 22, a storage device 23, a printer 24, and various input devices (e.g., a mouse 26, keyboard 27) to include biometric login devices. Those skilled in the art will recognize that biometric devices compatible with the present invention are not limited to the exemplary devices shown in FIG. 1 which include a fingerprint scanner 17 and microphone (voice recognition) 19. Consequently, suitable input devices may comprise any mechanism configured to receive BIR data. Server computer 16 may be similarly configured, albeit typically with greater processing performance and storage capacity, as is well known in the art.

FIG. 2 illustrates a hardware and software environment for an apparatus 30 suited to control biometric access with regard to a user in a manner consistent with the principles of the invention. For the purposes of the invention, apparatus 30 may represent a computer, computer system or other programmable electronic device, including: a client computer (e.g., similar to computers 12, 14 and 20 of FIG. 1), a server computer (e.g., similar to server 16 of FIG. 1), a portable computer, an embedded controller, etc. Apparatus 30 will hereinafter also be referred to as a “computer,” although it should be appreciated the term “apparatus” may also include other suitable programmable electronic devices consistent with the invention.

Computer 30 typically includes at least one processor 31 coupled to a memory 32. Processor 31 may represent one or more processors (e.g., microprocessors), and memory 32 may represent the random access memory (RAM) devices comprising the main storage of computer 30, as well as any supplemental levels of memory, e.g., cache memories, non-volatile or backup memories (e.g., programmable or flash memories), read-only memories, etc. In addition, memory 32 may be considered to include memory storage physically located elsewhere in computer 30, e.g., any cache memory in a processor 31, as well as any storage capacity used as a virtual memory, e.g., as stored within a biometric database 36 or on another computer coupled to computer 30 via network 38.

Computer 30 also may receive a number of inputs and outputs for communicating information externally. For interface with a user, computer 30 typically includes one or more input devices 33 (e.g., a keyboard, a mouse, a trackball, a joystick, a touchpad, retinal/fingerprint scanner, and/or a microphone, among others) and a display 34 (e.g., a CRT monitor, an LCD display panel, and/or a speaker, among others). It should be appreciated, however, that with some implementations of computer 30, e.g., some server implementations, direct user input and output may not be supported by the computer, and interface with the computer may be implemented through a client computer or workstation networked with computer 30.

For additional storage, computer 30 may also include one or more mass storage devices 36 configured to store a biometric database 37. Exemplary devices 36 can include: a floppy or other removable disk drive, a hard disk drive, a direct access storage device (DASD), an optical drive (e.g., a CD drive, a DVD drive, etc.), and/or a tape drive, among others. Furthermore, computer 30 may include an interface with one or more networks 38 (e.g., a LAN, a WAN, a wireless network, and/or the Internet, among others) to permit the communication of information with other computers coupled to the network. It should be appreciated that computer 30 typically includes suitable analog and/or digital interfaces between processor 31 and each of components 32, 33,34, 36 and 38.

Computer 30 operates under the control of an operating system 40, and executes various computer software applications, components, programs, objects, modules, etc. (e.g., BIR caching program 50, disconnected login program 42, and fast login program 44, HA-API 43, among others). Of note, Human Authentication Application Programming Interface (HA-API) regards an exemplary programming interface supplied by biometric service providers that provides enrollment and verification services for installed biometric devices. Moreover, various applications, components, programs, objects, modules, etc. may also execute on one or more processors in another computer coupled to computer 30 via a network 38, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions will be referred to herein as “computer programs,” or simply “programs.” The computer programs typically comprise one or more instructions that are resident at various times in various computer memory and storage devices. When a program is read and executed by a processor, the program causes the computer to execute steps or elements embodying the various aspects of the invention.

Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

### BIR Caching

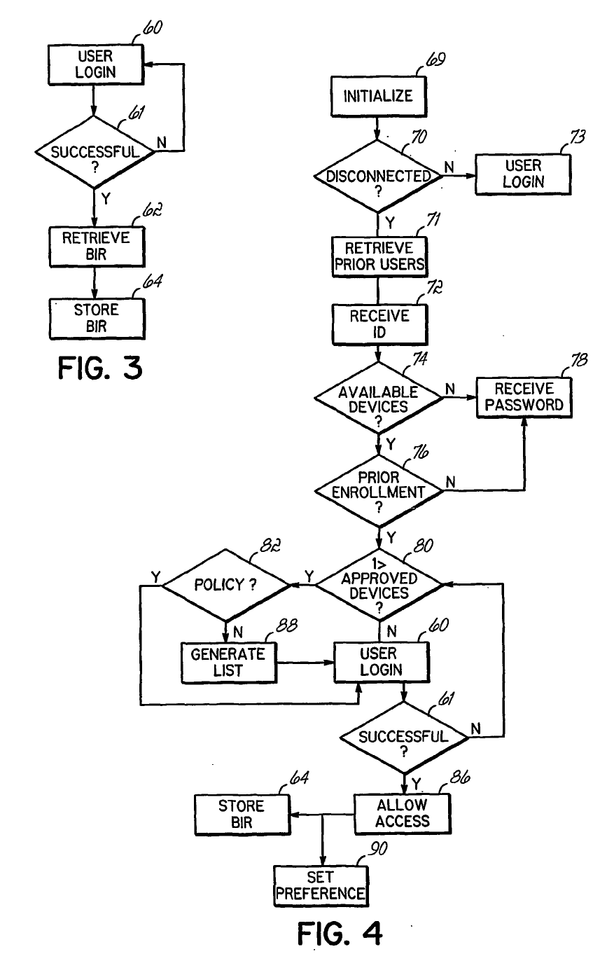

The flowchart of FIG. 3 illustrates an exemplary embodiment for biometrically controlling access of a user with regard to the hardware and software environments of FIGS. 1 and 2. Generally, BIR caching calls for the local storage of enrollment BIR data correlated with a privileged user. The BIR caching program of FIG. 2 causes an accessing user to provide capture BIR data to a local computer when accessing a network server. One embodiment retrieves and stores the enrollment BIR data from the server following a successful network login. As discussed below, such enrollment data may have application for facilitating remote and accelerated user access.

More particularly, FIG. 3 illustrates sequenced steps suited to locally store enrollment BIR data correlated with a user, subsequent to the user gaining access to a network. At block 60, the BIR caching program may recognize that a user is attempting to log into a computer system biometrically. As discussed above, this may involve fingerprint/voice recognition, retinal scans, or other known biometric techniques and procedures. Of note, should the BIR caching program detect a unsuccessful biometric logon at block 61 (as defined by the particular biometric testing application), then the BIR caching processes described below in steps 62-64 go unexecuted. In this manner, local storage of the BIR data may only be accomplished after a successful biometric login to the network registers at block 61.

Assuming the user successfully gains access to the network at block 61, BIR caching software incident on the local machine of the user retrieves the enrollment BIR of the user at block 62. The retrieval may involve recording the BLR from the network server at block 62. As such, the program will access network data base files to download the BLR onto the hard drive of the user's computer. Alternatively, the program may simultaneously record the enrollment BLR as it is used to authenticate the user at block 60. As such, the program may initiate local storage of the BLR data incident with a successful login attempt at block 61.

A third embodiment may prompt a logged-in user to resubmit capture BIR data used explicitly for storage on the local hard drive of the user's computer. For instance, the user may re-accomplish the biometric authentication sequence used to gain access at block 60. As such, the program may cache the capture BLR data for later use on the same computer.

In any case, the program stores and associates the retrieved BLR with the LD and/or operating system password information of the user. The BLR data and associative relationships are stored within memory of the computer at block 64. Of note, the memory may comprise a cache or database configured for quick retrieval of the BIR data. The program may further structure the memory to sequentially store BIR and ID information for a preset number of recent users. This feature may prove convenient in situations where multiple users exclusively share a computer. For instance, the program can initiate a display of the ten most recent users to access the computer. In this manner, an accessing user may select their displayed ID from a scroll down bar menu as discussed below in detail.

The selection prompts the program to retrieve the enrollment BIR data and other information associated with the user from the hard drive of the local computer. This provision facilitates login processes by enabling a direct comparison between the stored and capture BIR data. Of note, the BIR caching method of FIG. 3 may be repeated every rime a user successfully logs into a computer. As such, the most recently stored BIR data accounts for subtle, physical changes in the biometric characteristics of the user that can occur over time.

### Disconnected Login

The methodology of the steps of FIG. 3 have application within the disconnected login sequence illustrated in FIG. 4. Generally, the BIR caching sequence of FIG. 3, integrated into the flowchart of FIG. 4, allows a user who has been successfully granted access to a network via biometric authentication to subsequently use the same BIR to access the client computer when disconnected from the network. Once a user has logged into the network through a specific computer, enrollment BLR data from the network is downloaded into the memory of the disconnected computer for subsequent access to the computer on a local basis. Of note, enrollment BLR data may not be retrieved until after the accessing user has authenticated their data for the first time.

In this manner, the disconnected login program of FIGS. 2 and 4 enables a user accessing a computer separated from network communications to nonetheless gain access to it biometrically. Significantly, the user accesses the detached computer using the same BLR that is stored on the network. Absent such provision, a remote user would be unable to biometrically access their account. Of note, the flowchart of FIG. 4 presupposes that an account has been established for the user, as discussed in the text accompanying FIG. 3.

Turning more particularly to block 69 of FIG. 4, the user may initiate normal startup processes at a computer terminal. For instance, the user may boot the computer or initiate proprietary software resident on the machine. For example, protocol may require all users to depress a sequence of keyboard symbols to initiate program execution. In response, the computer may activate the disconnected login program 42 of FIG. 2 at block 70 of FIG. 4. In one embodiment, the program may initially query a server, operating system, or user input to determine if disconnected login processes are required or requested.

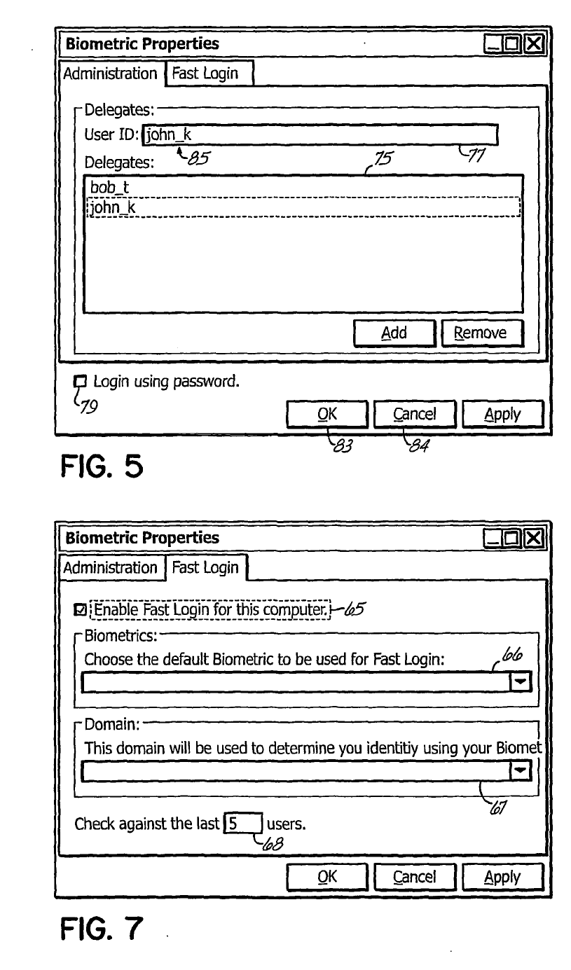

If such a determination is made at block 70 of FIG. 4, then the program may retrieve at block 71a list of prior users who have most recently logged into the machine. Of note, the storage of the data associated with the users is accomplished locally at the client computer. This feature obviates any requirement to communicate with the network to retrieve prior user data. As above, the computer may display the list of users in the form of a drop-down screen box. An administrator may set the number of user ID's displayed according to application and performance considerations. As such, a user may scroll down the drop-down box to select their name at block 72. If the name of an accessing user is not displayed by the computer at block 71, the embodiment may present the user with the option of typing their name onto a text field. FIG. 5 shows a suitable dialog box having such a text field 77 and drop-down box 75. As shown in FIG. 5, the user may submit their designated user name 85 by depressing the “OK” button 83. The user may alternatively end a login session by selecting the “Cancel” button 84. In one embodiment, the dialog box may further include a password login option 79. As such, a client may access the computer using the conventional password option of block 78 of FIG. 4 so long as allowed by the system administrator. Another embodiment may require users to access their accounts using their conventional password in combination with biometric processes.

The program may subsequently evaluate which biometric devices are installed and available on the local machine at block 74 of FIG. 4. For example, the local computer of the user may be equipped with both fingerprint and retinal biometric testing devices. Proprietary programs associated with conventional biometric testing devices place a marker within a registry of the computer upon installation and de-installation. This registry provides a mechanism for the embodiment to assess available devices at block 74. If no device is configured or available on the computer, then the user must login using a password if the option is available at block 78.

At block 76, the computer may determine whether biometric enrollment on an available device has ever taken place on the computer with regard to the user desiring access. If not, then the user may again be relegated to the password entry of block 78. Should the computer alternatively determine that the user has previously logged in using a biometric device detected at block 74, then the disconnected login program may next determine whether more than one biometric login device is available on the machine. Of note, should only one biometric device be available and previously accessed, the program may initiate authentication processes directly at block 60.

Should the program determine that more than one device is available and previously utilized at block 80, then the embodiment may check to see if a policy setting has been established for the user at block 82. Such a setting acts as a default, or preference for a particular user, directing the computer to select a single or ordered group of biometric devices from among the available devices. As discussed herein, such a preference may be set by an administrator or designated by a prior designation of the user. For instance, the user may set a preference subsequent to login at block 90, as discussed below.

Should the program detect a preferred setting at block 82 that corresponds to an allowable testing device, then it may initiate testing sequences associated with the preferred biometric device at block 60. Should no single, biometric testing preference be recorded for the user at block 82, then one embodiment may prompt the user to select a biometric testing sequence at block 88 from a listing displayed at the terminal. As such, the user may select one or more biometric verification processes by typing in or clicking on a device displayed at block 88. The program may derive the list from those installed devices detected at block 74.

In response to any such designation, the program retrieves software associated with the designated biometric in preparation of the biometric challenge at block 60. The program then launches the designated/preferred biometric test according to the preset parameters of the biometric verification sequence. Should the verification process be unsuccessful at block 61, the program relegates the user back to block 80 to select from the same or other available biometric login devices. Of note, the respective login protocol may allow for multiple authentication attempts at block 61 before ending a session. Otherwise the user accesses the computer at block 86. The BIR enrollment data associated with the login may then be stored at block 64 along with other user data, as discussed above in the BLR caching sequences of FIG. 3. The privileged user may additionally click on a dialog box at block 90 to set a biometric preference for subsequent logon sessions.

FIG. 7 shows an exemplary dialog box suited for application within the processes of FIG. 4. As shown, the user may select a desired domain 67 that the program will locate upon a subsequent login session or after initialization processes of block 69 of FIG. 4. As such, the domain may relate to program and interface addresses required by the user to gain access to a biometric challenge. In another embodiment, domain selection may be transparent to the user as set by an administrator or software precept. Similarly, the user may enter a preferred biometric login device with a preference field 66 of FIG. 7. As discussed above, this preference may direct policy determinations regarding login devices at block 82 of FIG. 4 on subsequent login sessions. Thus, in use, the disconnected login feature frees up network resources, as an authentication process may be conducted without taxing CPU cycles of the central server.

### Fast Login

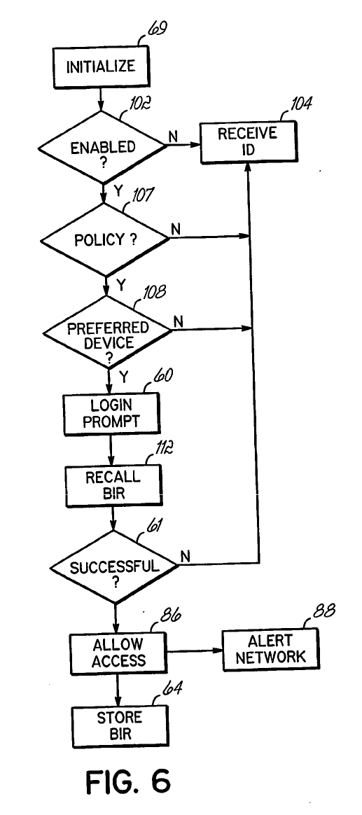

Another embodiment consistent with the principles of the present invention and shown in FIG. 6 allows an accessing user to biometrically access a computer without first providing another source of identification. Of note, the embodiment may operate within the confines of the disconnected login processes of FIG. 4. To this end, the dialog box of FIG. 7 includes a “Fast Login” option 65 as discussed below. A system administrator may additionally configure multiple, networked computers to enable an accelerated biometric login. Such a designation obviates the conventional user requirement of providing the ID for the enabled client computers.

Unlike prior art systems, an accessing user merely provides capture BIR data at the local computer. For instance, the accessing user's first interaction with a machine may comprise the placement of an index finger onto a scanner in communication with the computer. Similarly, a microphone coupled to the computer may recognize the voice pattern of the accessing user without first requiring identification information. Program software running on the computer compares capture BIR data to stored enrollment BIR data and determines if a match is present. In the event of such a match, the program may retrieve and configure an ED and password associated with the enrollment BIR data to verify privileged access status of the user.

FIG. 6 shows sequence steps suited to realize the fast login process described above. At block 69, the accessing user initiates any necessary, preliminary processes associated with the computer, operating system and/or network. For instance, the user may have to strike a particular combination on a keyboard, or merely power-up the computer. As discussed below in detail, the initialization sequence may prompt a fast login program to retrieve cached BLR data. At block 102, the program may first confirm that the computer/server is configured to allow fast login. For instance, a most recent user accessing the computer may check the “Fast Login” box 65 of FIG. 7 during normal login or log-out processes. Such a designation causes the fast login program to automatically initiate during subsequent login sessions.

Alternatively or in addition, a system administrator may set the domain of the computer and/or network such that the computer software locates the fast login address upon initialization at block 69. In either case, the computer accessed by the user recognizes at block 102 that fast login has been enabled. Regarding block 69, some computers and networks may not require such initialization processes, and rather allow the user to proceed directly to block 107. Of note, should fast login be disabled for the computer at block 102, the conventional login sequence for the computer may be invoked at block 104. Namely, the user may be prompted to enter in their ID prior to submitting capture BIR data.

In response to detecting an enabled fast login, the computer may execute further fast login software processes at block 107. More particularly, the program may determine if a policy has been established for the accessed computer. A policy may include a programmed preference or mandate for a biometric testing device established by an administrator or a prior user. Should a connection to the network be established, the computer may similarly query the server for a biometric testing device preference(s). Of note, should no preference be available via the server, the program may substitute a default preference, not shown in the embodiment of FIG. 6. The default preference, as discussed herein, may track a compilation of available biometric devices on the machine and ascertained at block 108. The policy may further be specific to fast login applications. Alternatively at block 107, the absence of a preference may cause the program to force the user to provide an ID at block 104.

The fast login program may at block 108 determine which, if any, of the preferred biometric testing devices are actually installed on the computer. To this end, the software program may query a registry value of the operating system at block 108. As is known, such registries contain information entered incident upon the installation of a biometric testing device. In this manner, the register provides an accounting of devices installed on the computer. In an instance where the computer is in communication with the network, the computer may alternatively check the server to obtain status information pertinent to available biometric devices. Should no acceptable or preferred biometric testing device be located on the computer at block 108, the software will, as above, relegate the user to conventional LD login at block 104.

Should the preferred biometric testing device be thus available and approved, the user may be prompted to provide the appropriate capture BLR data at block 60. More particularly, the program may initiate and display a splash screen configured to cause the user to provide the preferred and appropriate biometric testing data. For instance, a fingerprint authentication application may prompt the user, “please place finger on pad.” At block 60, the user may provide the appropriate capture BLR data. The computer, in turn, retrieves the capture BLR data according to the known biometric login sequence appropriate to the preferred testing device.

In response to receiving the capture BLR data at block 60, the software may recall at block 112 a stored list of ID's and associated enrollment BLR data corresponding to a number of most recent users accessing the computer. The program may limit the number of prior users stored to 5-10 for processing and time considerations. Of note, however, an administrator may increase or decrease the number of users stored per application and CPU resource availability. For instance, an administrator could configure hundreds of workstations for fast login given adequate processing resources.

At block 61, the program may attempt to verify the capture BIR data using the retrieved history of recent logins. That is, the program sequentially evaluates stored enrollment BIR data until a numerical match is detected. Of note, the program may begin evaluating the stored data in chronological order beginning with the most recent user to access the computer. Once a match is detected, the program may transparently recall and present any ID or password information associated with the matched BIR that is required by an operating system. As discussed below, this feature fulfills vendor and system requirements while liberating an accessing user from password/ID redundancies. As shown in FIG. 7, a privileged user may enter within a text field 68 the number of prior users against which the program verifies the capture BIR data.

Should the biometric match be detected at block 61, then the user gains access to the desired resources of the computer and/or network at block 86. Of note, one embodiment may repeat unsuccessful authentication processes at block 61 three to five times prior to directing the client to use conventional user ID login sequences at block 104. The fast login program may cache a successful biometric login memory at block 64, as well as alert the network server as to the successful login at block 88. This step may provide an additional layer of security to a network by insuring that the same user is not accessing the network concurrently from two separate locations. Thus, in use, the fast login feature enables a user to bypass presentation of user identification information and merely provide an enrollment data to access the computer.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. For example, a program of the invention may encrypt biometric data, conventional passwords and other information at any step delineated in the flowcharts of FIGS. 3, 4 and 6.

Further, one skilled in the art should appreciate that any of the embodiments and associated programs discussed above are compatible with all known biometric testing processes and may further be optimized to realize even greater efficiencies. For instance, an operating system executing a program of the invention may dictate a login path or routine. The operating system or administrator may define the login path that consists of, for instance, a password followed by a fingerprint scan. As such, the operating system may require both the password and a BIR. Thus, software of the present invention works within and complements the HA-API to transparently associate, retrieve and present the password associated with the BIR enrollment data of the accessing user along with the capture BIR data.

More specifically, the password associated with the stored BIR data is retrieved from cached memory and sent to the operating system. In this manner, the programming requirements of the operating system and biometric vendor are fulfilled without burdening the accessing user with conventional password requirements. The invention in its broader aspects is, therefore, not limited to the specific details, representative apparatus and method, and illustrative examples shown and described. Accordingly, departures may be made from such details without departing from the spirit or scope of the general inventive concept.

Having described the invention, what is claimed is:

1-88. (canceled)

89. A method of biometrically controlling a user's access to a secure computer system; the method comprising:
storing at a server, enrollment BIR data correlated with a privileged user;
receiving, at the server, capture BIR data from a user requesting access to the secure computer system via a client computer;
comparing the capture BIR data to the enrollment BIR data to determine whether the user is to be granted access to the network as a privileged user via the computer; and
if so granted, thereafter storing a copy of the enrollment BIR data in memory of the client computer for use during subsequent access requests.

90. The method of claim 89 further comprising receiving enrollment BIR data from a plurality of users requesting access to the secure computer system from the client computer and storing the enrollment BIR data for those users granted access in the memory of the client computer.

91. The method of claim 90 further comprising receiving identification information for the plurality of users and storing the identification information in the memory of the client computer.

92. The method of claim 90 further comprising receiving, at the client computer, a request to access the client computer, the request including capture BIR data, and, in response, comparing the capture BIR data to the enrollment BIR data stored at the client computer.

93. The method of claim 92 wherein the enrollment BIR data is stored at the client computer sequentially according to the order the order the users were granted access to the secure computer system.

94. The method according to claim 89, further comprising encrypting the enrollment BIR data at the client computer.

95. A system for biometrically controlling a user's access to a secure computer system, the system comprising:
a memory;
a database resident within the memory, the database storing enrollment BIR data retrieved from a network and correlated with a privileged user; and
a computer program module executable by a processor, the computer program module configured to (i) prompt an accessing user to provide capture BIR data to the computer, (ii) compare the capture BIR data to the enrollment BIR data to determine whether the user is to be granted access to the network as a privileged user via the computer, and (iii) if so granted, thereafter storing a copy of the enrollment BIR data in memory of the client computer for use during subsequent access requests.

96. The system of claim 95 wherein the computer program module is further configured to receive enrollment BIR data from a plurality of users requesting access to the secure computer system from the client computer and storing, in the memory, the enrollment BIR data for those users granted access.

97. The system of claim 96 wherein the computer program module is further configured to receive identification information for the plurality of users and storing the identification information in the memory.

98. The system of claim 96 wherein the computer program module is further configured to receive a request to access the computer, the request including capture BIR data, and, in response, compare the capture BIR data to the enrollment BIR data stored in the memory.

99. The system of claim 98 wherein the computer program module is further configured to store the capture BIR data sequentially according to the order the order the users were granted access to the computer.

100. The system of claim 95, wherein the computer program module is further configured to encrypt the enrollment BIR data.
